(19) United States
(12) Patent Application Publication
(10) Pub. No.: US 2025/0356692 A1
(43) Pub. Date: Nov. 20, 2025

(54) ONLOOKER DETECTION SYSTEM AND ONLOOKER DETECTION METHOD

(71) Applicant: REALTEK SEMICONDUCTOR CORP., Hsinchu (TW)

(72) Inventors: Chao-Hsun Yang, Hsinchu (TW); Chih-Yuan Koh, Hsinchu (TW); Shih-Tse Chen, Hsinchu (TW)

(73) Assignee: REALTEK SEMICONDUCTOR CORP., Hsinchu (TW)

(21) Appl. No.: 18/958,661

(22) Filed: Nov. 25, 2024

(30) Foreign Application Priority Data
May 14, 2024 (TW) 113117800

(51) Int. Cl. G06V 40/16; G06F 21/60; G06T 7/73; G06V 10/82

(52) U.S. Cl. CPC G06V 40/172; G06F 21/60; G06T 7/73; G06V 10/82; G06V 40/171; G06T 2207/20084; G06T 2207/30201

(57) ABSTRACT

An onlooker detection system and an onlooker detection method are provided. The onlooker detection system includes: a person detection module, configured to receive an image, and obtain, in response to presence of persons in the image, person information of each person, where the person information includes distance information relative to a device; and an onlooker determination module, configured to: determine whether the persons include at least one non-user present in a range based on the distance information of the person information of each person; and determine, in response to presence of the at least one non-user in the range, a security classification to which each non-user belongs based on the person information of each non-user, where the security classification includes an onlooker category.

### CROSS-REFERENCE TO RELATED APPLICATION

This non-provisional application claims priority under 35 U.S.C. § 119(a) to Patent Application No. 113117800 filed in Taiwan, R.O.C. on May 14, 2024, the entire contents of which are hereby incorporated by reference.

### BACKGROUND

### Technical Field

The present disclosure relates to the technical field of information display security, and in particular, to a technology of determining a security classification of a non-user in an image by using a characteristic of the non-user.

### Related Art

In recent years, with increasing awareness of information security, a function of detect an onlooker by using a depth map is introduced into many systems and applications, to ensure privacy and security of users. However, when a person passes through a rear of a user without any peeping behavior, determination using only depth information in a depth map may lead to a false alarm.

### SUMMARY

In view of the above, some embodiments of the present invention provide an onlooker detection system and an onlooker detection method, to alleviate the problem of the related art.

Some embodiments of the present invention provide an onlooker detection system, including: a person detection module, configured to receive an image, and obtain, in response to presence of persons in the image, person information of each person, where the person information includes distance information relative to a device; and an onlooker determination module, configured to: determine whether the persons include at least one non-user present in a range based on the distance information of the person information of each person; and determine, in response to presence of the at least one non-user in the range, a security classification to which each non-user belongs based on the person information of each non-user, where the security classification includes an onlooker category.

Some embodiments of the present invention provide an onlooker detection method, including: receiving an image and obtaining, in response to presence of at least one person in the image, person information of each person, by a person detection module, where the person information includes distance information relative to a device; and determining, by an onlooker determination module, whether the at least one person includes at least one non-user present in a range based on the distance information of the person information of each person; and determining, in response to presence of the non-user in the range, a security classification to which each non-user belongs based on the person information of each non-user, where the security classification includes an onlooker category.

Based on the above, according to the onlooker detection system and the onlooker detection method provided in the embodiments of the present invention, various types of information is obtained through vision to comprehensively evaluate a status of a person in an image obtained by a lens, thereby increasing accuracy of determination.

### BRIEF DESCRIPTION OF THE DRAWINGS

FIG. 1 is a block diagram of an onlooker detection system according to some embodiments of the present invention.

FIG. 2 to FIG. 5 are schematic diagrams of operation of a person detection module according to some embodiments of the present invention.

FIG. 6 is a schematic diagram of detection according to some embodiments of the present invention.

FIG. 7 is a schematic diagram of a key point according to some embodiments of the present invention.

FIG. 8 is a schematic diagram of angle information corresponding to face information according to some embodiments of the present invention.

FIG. 9 is a schematic diagram of distance measurement according to some embodiments of the present invention.

FIG. 10 is a block diagram of a neural network module according to some embodiments of the present invention.

FIG. 11 is a block diagram of an output feature tensor generation module according to some embodiments of the present invention.

FIG. 12 is a block diagram of a fusion module according to some embodiments of the present invention.

FIG. 13 is a schematic structural diagram of a prediction module according to some embodiments of the present invention.

FIG. 14 is a schematic structural diagram of an information tensor according to some embodiments of the present invention.

FIG. 15 is a system block diagram of an electronic device according to some embodiments of the present invention.

FIG. 16 to FIG. 22 are flowcharts of an onlooker detection method according to some embodiments of the present invention.

### DETAILED DESCRIPTION

The above and other technical contents, features, and effects of the present invention are clearly presented in the following detailed description of embodiments with reference to drawings. Any modification and change that do not affect efficacy and objectives of the present invention shall fall within scope of the technical contents disclosed in the present invention.

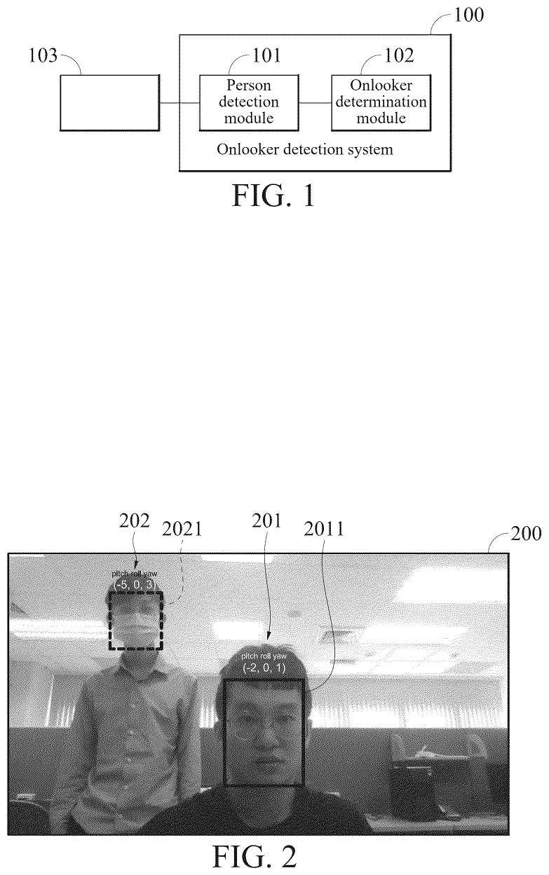

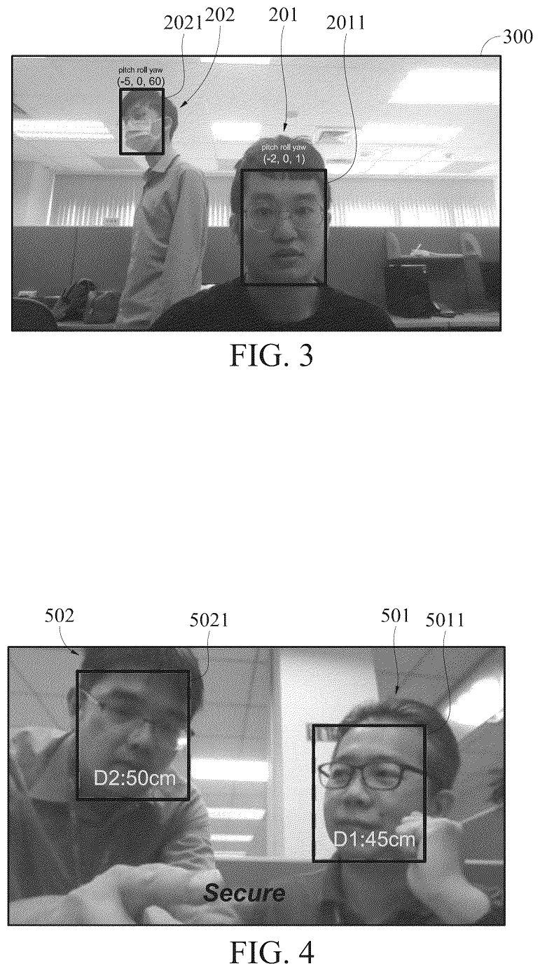

FIG. 1 is a block diagram of an onlooker detection system according to some embodiments of the present invention. FIG. 2 to FIG. 3 are schematic diagrams of operation of a person detection module according to some embodiments of the present invention. Referring to FIG. 1 to FIG. 3, an onlooker detection system 100 includes a person detection module 101 and an onlooker determination module 102. The person detection module 101 is configured to receive an image 103 (for example, an image 200 in FIG. 2 or an image 300 in FIG. 3), and obtain, in response to presence of at least one person in the image 103 (for example, persons 201-202 in the image 200 in FIG. 2 and the image 300 in FIG. 3), person information of each person, where the person information includes distance information relative to a device. The device, for example, is a display screen of an electronic device, and the distance information relative to the device included in the person information includes a distance of the person in the image relative to the display screen of the electronic device. The onlooker determination module 102 is configured to receive the person information of the person detected by the person detection module 101 and perform further determination and processing.

In some embodiments of the present invention, the person detection module 101 first determines a person in the image 103 that is a user. The person detection module 101 may determine that a person closest to the device is the user, or may first identify a plurality of persons closest to the device and then identify a person closest to a center as the user. A method for determining the user is not limited in the present invention. Taking the image 200 in FIG. 2 and the image 300 in FIG. 3 as an example, the person detection module 101 determines that the person 201 is the user. In the Image 103, all non-user persons are referred to as non-users.

An onlooker detection method and cooperation between modules of an onlooker detection system 100 in some embodiments of the present invention are described in detail below with reference to the drawings.

FIG. 16 is a flowchart of an onlooker detection method according to some embodiments of the present invention. Refer to FIG. 1 to FIG. 3 and FIG. 16. In the embodiment of FIG. 16, the onlooker detection method includes steps S1601 to S1603. In step S1601, the person detection module 101 receives the image 103, and obtains, in response to presence of persons in the image, person information of each person, where the person information includes distance information relative to a device. In step S1602, the onlooker determination module 102 determines whether the persons include a non-user present in a range based on the distance information of the person information of the persons detected by the person detection module 101. For example, the device is a display screen of an electronic device, and the range is set to a preset distance in front of the display screen of the electronic device.

In step S1603, the onlooker determination module 102 determines, in response to determining that at least one non-user is present in the range, a security classification to which each non-user belongs based on the person information of each non-user, where the security classification includes an onlooker category. That the onlooker determination module 102 determines that a non-user belongs to the onlooker category means that the onlooker determination module 102 determines that the non-user is at risk of peeping the device.

FIG. 17 is a flowchart of an onlooker detection method according to some embodiments of the present invention. Refer to FIG. 2 to FIG. 3 and FIG. 17. In the embodiment of FIG. 17, in addition to the onlooker category, the above security classification further includes a non-onlooker category. That the onlooker determination module 102 determines that a non-user belongs to the non-onlooker category means that the onlooker determination module determines that the non-user is not at risk of peeping the device. Step S1603 includes steps S1701-S1706. In step S1701, the onlooker determination module 102 determines, for a current object of the at least one non-user, whether the current object faces the device. If yes, step S1702 is performed. If no, step S1703 is performed. In step S1702, determine that the current object belongs to the onlooker category in response to the current object facing the device. In step S1703, determine that the current object belongs to the non-onlooker category in response to the current object not facing the device. For example, in FIG. 2 and FIG. 3, the onlooker determination module 102 determines that the person 201 is a user, and the person 202 is a non-user within the range. In FIG. 2, the onlooker determination module 102 determines that the person 202 belongs to the onlooker category. In FIG. 3, the onlooker determination module 102 determines that the person 202 belongs to the non-onlooker category. In step S1704, the onlooker determination module 102 determines whether the at least one non-user includes an unselected object. If yes, step S1706 is performed. If no, step S1705 is performed. In step S1705, the onlooker determination module 102 exits the program after determining security classifications of all non-users. In step S1706, the onlooker determination module 102 selects, in response to the at least one non-user including the unselected object, an unselected one of the at least one non-user as the current object, and returns to step S1701.

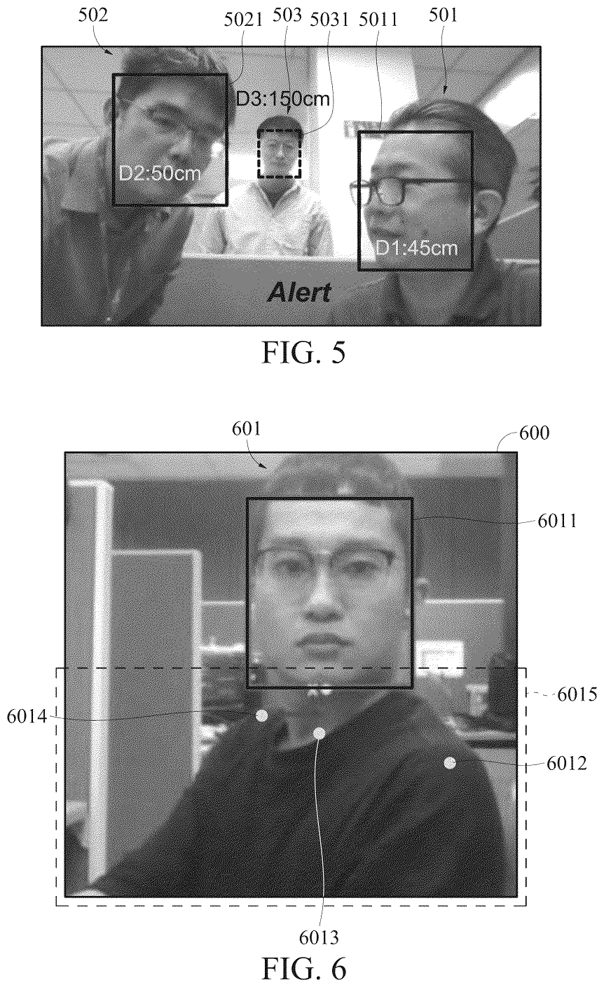

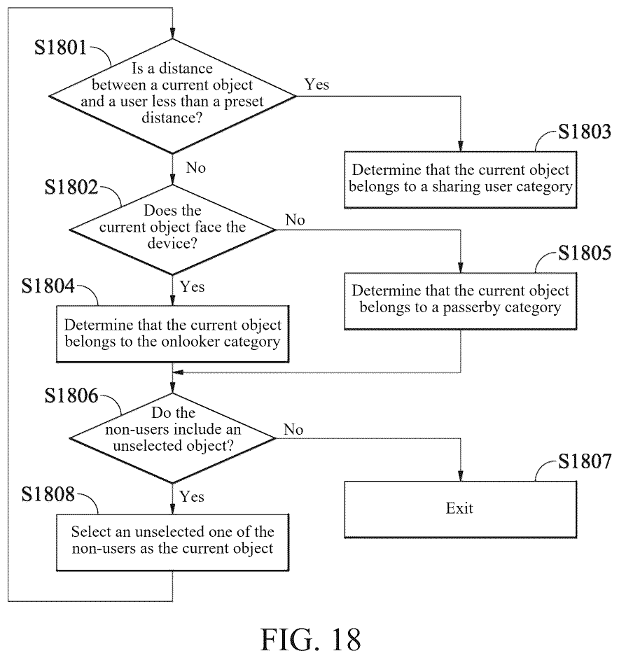

FIG. 4 to FIG. 5 are schematic diagrams of operation of a person detection module according to some embodiments of the present invention. FIG. 18 is a flowchart of an onlooker detection method according to some embodiments of the present invention. Refer to FIG. 4 to FIG. 5 and FIG. 18. In FIG. 18, in addition to the onlooker category, the above security classification further includes a passerby category and a sharing user category. That the onlooker determination module 102 determines that a non-user belongs to the passerby category means that the non-user has no peeping intention though being located in a peeing range. That the onlooker determination module 102 determines that a non-user belongs to the sharing user category means that the onlooker determination module determines that the non-user is a person sharing information content with the user. Step S1603 includes steps S1801-S1808. In step S1801, the onlooker determination module 102 determines, for a current object of the at least one non-user, whether a distance between the current object and the user is less than a preset distance. If yes, step S1803 is performed. If no, step S1802 is performed. In step S1803, determine, in response to the distance between the current object and the user being less than the preset distance, that the current object belongs to the sharing user category. In step S1802, the onlooker determination module determines, in response to the distance between the current object and the user being not less than the preset distance, whether the current object faces the device. If yes, step S1804 is performed. If no, step S1805 is performed.

In some embodiments of the present invention, the onlooker determination module 102 calculates the distance between the current object and the user based on the distance information of each person relative to the device. In FIG. 4, a distance of a person 502 determined as a non-user relative to the device is 50 cm, and a distance of a person 501 determined as a user relative to the device is 45 cm. Therefore, the onlooker determination module 102 determines that a distance between the person 502 and the person 501 is 50 cm−45 cm=5 cm. In FIG. 5, a distance of a person 503 determined as a non-user relative to the device is 150 cm. Therefore, the onlooker determination module 102 determines that a distance between the person 503 and the person 501 is 150 cm−45 cm=105 cm.

In step S1804, determine that the current object belongs to the onlooker category in response to the current object facing the device. In step S1805, determine that the current object belongs to the passerby category in response to the current object not facing the device. In step S1806, the onlooker determination module 102 determines whether the at least one non-user includes an unselected object. If yes, step S1808 is performed. If no, step S1807 is performed. In step S1807, the onlooker determination module 102 exits the program after determining security classifications of all non-users. In step S1808, the onlooker determination module 102 selects, in response to the at least one non-user including the unselected object, an unselected one of the at least one non-user as the current object, and returns to step S1801.

FIG. 19 is a flowchart of an onlooker detection method according to some embodiments of the present invention. In FIG. 19, the above person information includes face information, angle information corresponding to the face information, and key point information. The face information includes positions, heights, and widths of face boxes (for example, face boxes 2011 and 2021 in FIGS. 2 to 3 and face boxes 5011, 5021, and 5031 in FIG. 4 to FIG. 5) of the detected persons. If a person is detected without a position, a height, and a width of a face box being present, it indicates that a face of the person is not detected. A further description is provided in subsequent embodiments. The above step of determining whether the current object faces the device include steps S1901-S1903 performed by the onlooker determination module 102. In step S1901, determine, based on face information of the current object, whether a face of the current object is detected. If yes, step S1902 is performed. If no, step S1903 is performed. In step S1902, determine whether the current object faces the device based on angle information of the current object corresponding to the face information in response to the face of the current object being detected. In step S1903, determine, in response to the face of the current object being not detected, whether the current object faces the device based on key point information of the current object.

FIG. 8 is a schematic diagram of angle information corresponding to face information according to some embodiments of the present invention. Referring to FIG. 8, a head of a face in the image 103 is shown by a head 804. A head pitch angle of the face in the image 103 is an angle by which a rotation is performed about an x-axis 801 from a face center of the head 804 facing the device, which is in a range of [−180°, 180°). A head yaw angle of the face in the image 103 is an angle by which a rotation is performed about a y-axis 802 from the face center of the head 804 facing the device, which is in a range of [−90°, 90°). A head roll angle of the face in the image 103 is an angle by which a rotation is performed about a z-axis 803 from the face center of the head 804 facing the device, which is in a range of [0°, 360°). When the face center of the head 804 is aligned with the device, the head pitch angle, the head yaw angle, and the head roll angle of the face are 0 degrees.

A gaze point pitch angle of the face in the image 103 is an angle by which a rotation is performed about the x-axis 801 from a gaze direction 805 of the head 804 facing the device, which is in a range of [−180°, 180°). A gaze point yaw angle of the face in the image 103 is an angle by which a rotation is performed about the y-axis 802 from the gaze direction 805 of the head 804 facing the device, which is in a range of [−90°, 90°). A gaze point roll angle of the face in the image 103 is an angle by which a rotation is performed about the z-axis 803 from the gaze direction 805 of the head 804 facing the device, which is in a range of [0°, 360°). When the gaze direction 805 of the head 804 is aligned with the device, the gaze point pitch angle, the gaze point yaw angle, and the gaze point roll angle of the face are 0 degrees.

In some embodiments of the present invention, the angle information of the current object corresponding to the face information includes a head yaw angle. Step S1902 includes: determining that the current object faces the device in response to the head yaw angle being within an angle threshold range, or determining that the current object does not face the device in response to the head yaw angle being not within the angle threshold range. FIG. 2 and FIG. 3 are used as an example. In FIG. 2 and FIG. 3, pitch represents a head pitch angle, roll represents a head roll angle, and yaw represents a head yaw angle, and the angle threshold range is ±10°). In FIG. 2, the head yaw angle of the person 202 is 3°, and therefore the onlooker determination module 102 determines that the person 202 faces the device. In FIG. 3, the head yaw angle of the person 202 is 60°, and therefore the onlooker determination module 102 determines that the person 202 does not face the device.

In some embodiments of the present invention, the angle information of the current object corresponding to the face information includes the gaze point yaw angle. Step S1902 includes: determining that the current object faces the device in response to the gaze point yaw angle being within an angle threshold range, or determining that the current object does not face the device in response to the gaze point yaw angle being not within the angle threshold range.

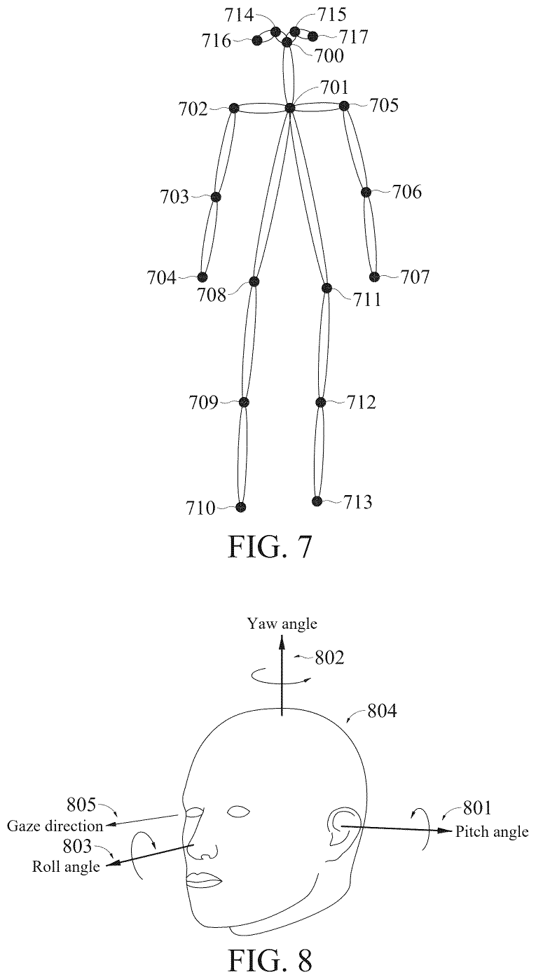

FIG. 6 is a schematic diagram of detection according to some embodiments of the present invention. FIG. 7 is a schematic diagram of a key point according to some embodiments of the present invention. Referring to FIG. 6 to FIG. 7, when the image 103 includes an image 600, the onlooker determination module 102 determines, based on received face information, that a face of a person 601 is detected. A face range of the person 601 is marked by a face box 6011. In this case, the onlooker determination module 102 performs step S1902. If the image 103 includes only the image 6015, the onlooker determination module 102 performs step S1903 to determine whether the current object faces the device based on the key point information of the current object. In FIG. 7, key points of a human body include a center 701, a left shoulder 705, a right shoulder 702, a left elbow 706, a right elbow 703, a left wrist 707, a right wrist 704, a left hip 711, a right hip 708, a left knee 712, a right knee 709, a left ankle 713, a right ankle 710, a nose 700, a left ear 717, a right ear 716, a left eye 715, and a right eye 714.

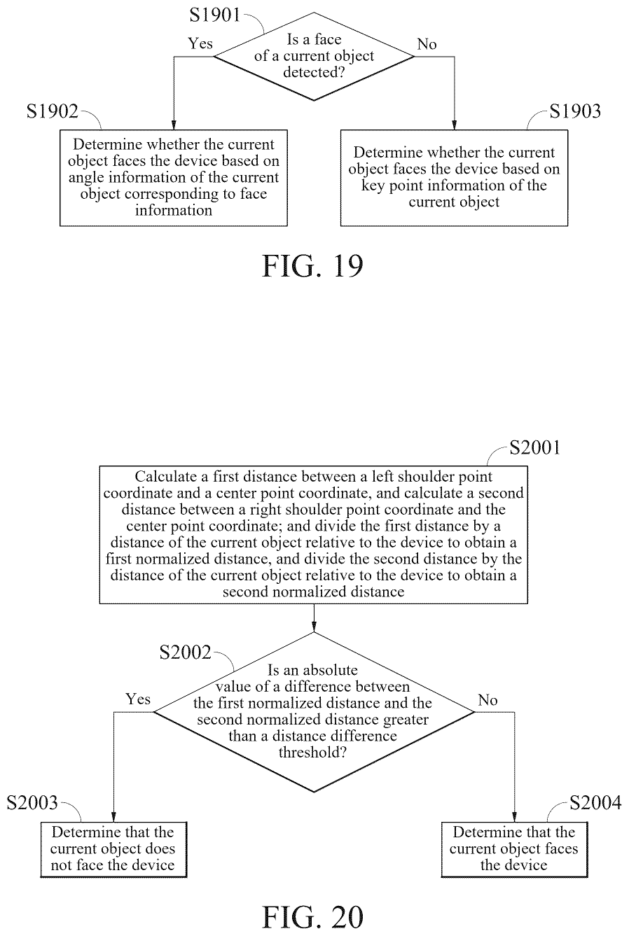

FIG. 20 is a flowchart of an onlooker detection method according to some embodiments of the present invention. In FIG. 20, the person detection module 101 detects the center 701, the left shoulder 705, and the right shoulder 702 of a person, to obtain a left shoulder point coordinate of a left shoulder point 6012, a right shoulder point coordinate of a right shoulder point 6014, and a center point coordinate of a center point 6013 as key point information. Step S1903 includes steps S2001-S2004. In step S2001, calculate a first distance between the left shoulder point coordinate and the center point coordinate, and calculate a second distance between the right shoulder point coordinate and the center point coordinate; and divide the first distance by a distance of the current object relative to the device to obtain a first normalized distance, and divide the second distance by the distance of the current object relative to the device to obtain a second normalized distance.

In step S2002, determine whether an absolute value of a difference between the first normalized distance and the second normalized distance is greater than a distance difference threshold (that is, determine whether an inequation of |First normalized distance−second normalized distance|>distance difference threshold is satisfied). If yes, step S2003 is performed. If no, step S2004 is performed. In step S2003, determine that the current object does not face the device in response to the aforementioned inequation being satisfied. Step S2004: Determine that the current object faces the device in response to the aforementioned inequation not being satisfied.

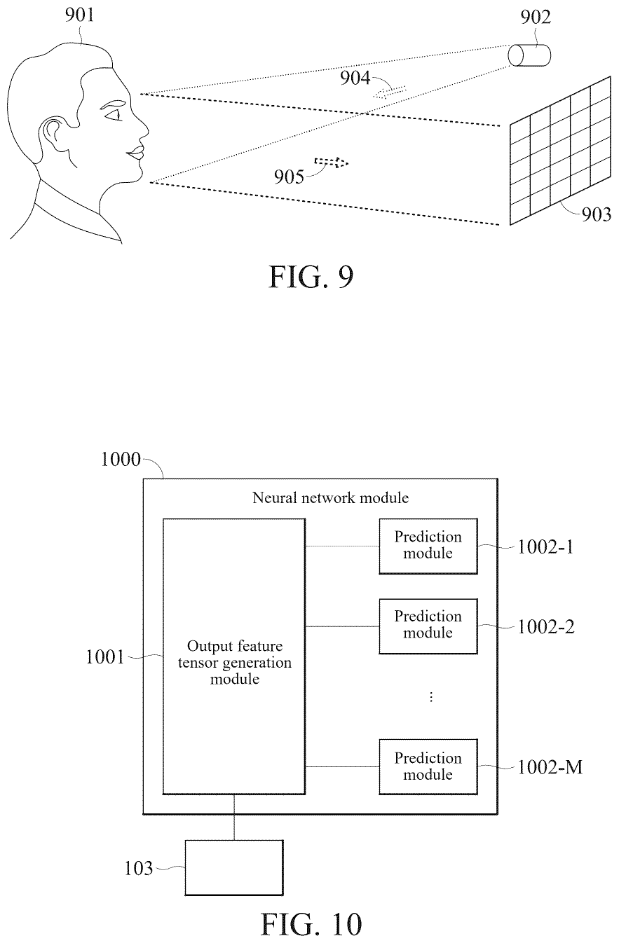

FIG. 9 is a schematic diagram of distance measurement according to some embodiments of the present invention. In FIG. 9, the person detection module 101 includes an infrared laser diode 902 and an infrared image sensor 903. The infrared laser diode 902 emits an infrared ray to a person 901 in a direction 904, and the infrared image sensor 903 receives reflection in a direction 905. The person detection module 101 calculates, as distance information in person information of the person 901, a distance of the person 901 relative to the device based on a time difference between the emission and the receiving of the reflection. It is worth noting that, estimation of a distance to a face may alternatively be achieved in other manners, such as obtaining a depth map by using a time of flight (TOF) sensor or a plurality of sensors (based on a phase difference method), or a single lens (mono camera) image estimation method.

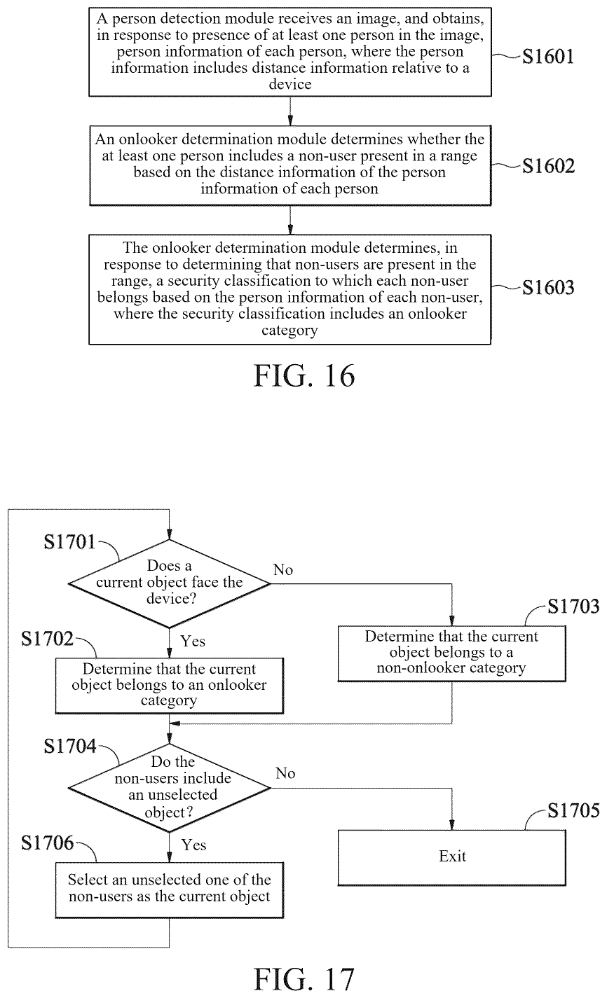

FIG. 15 is a system block diagram of an electronic device according to some embodiments of the present invention. In FIG. 15, an electronic device 1500 includes the onlooker detection system 100 and a display module 1501. The electronic device 1500 further includes a display screen, which is the device mentioned in the above embodiments. The display module 1501 controls the display screen. The onlooker detection method further includes: transmitting, by the onlooker determination module 102 in response to determining that one of the at least one non-user belongs to the onlooker category, a signal to cause the device to start initiating an anti-peeping program. In some embodiments of the present invention, the onlooker determination module 102 transmits a signal to the display module 1501 to control the display screen, so that the display screen switches from displaying Alert in FIG. 5 from displaying Secure in FIG. 4.

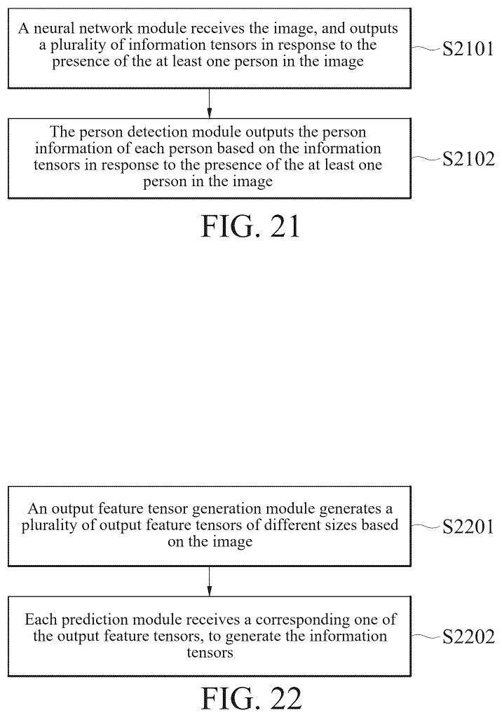

FIG. 10 is a block diagram of a neural network module according to some embodiments of the present invention. FIG. 21 is a flowchart of an onlooker detection method according to some embodiments of the present invention. Referring to FIG. 1, FIG. 10, and FIG. 21, in this embodiment, the person detection module 101 includes a neural network module 1000. The neural network module 1000 is configured to receive the image 103, and output a plurality of information tensors in response to the presence of the at least one person in the image. Step S1601 includes S2101 and S2102. In step S2101, the neural network module 1000 receives the image 103, and output a plurality of information tensors in response to the presence of the at least one person in the image 103. In step S2102, the person detection module 101 outputs the person information of each person based on the information tensors in response to the presence of the at least one person in the image 103.

A further description of various implementations of the neural network module 1000 is provided below. The neural network module 1000 includes an output feature tensor generation module 1001 and prediction modules 1002-1 to 1002-M, where M>1. The output feature tensor generation module 1001 generates a plurality of output feature tensors of different sizes based on the image 103. Each of the prediction modules 1002-1 to 1002-M receives one of the output feature tensors, to generate an information tensor correspondingly. The information tensor indicates face information, confidence score information, category information, angle information corresponding to the face information, and key point information. The person detection module 101 outputs, in response to the presence of the at least one person in the image 103, the person information of each person based on all information tensors generated by the prediction modules 1002-1 to 1002-M.

FIG. 22 is a flowchart of a determination method according to some embodiments of the present invention. Referring to FIG. 22, step S2101 includes steps S2201-S2202. In step S2201, the output feature tensor generation module 1001 generates a plurality of output feature tensors of different sizes based on the image 103. In step S2202, each of the prediction modules 1002-1 to 1002-M receives a corresponding one of the plurality of output feature tensors, to generate the information tensor respectively. Each of the information tensors is configured to indicate face information, confidence score information, category information, angle information corresponding to the face information, and key point information. The face information includes positions, heights, and widths of face boxes of the detected persons. If a person is detected without a position, a height, and a width of a face box being present, it indicates that a face of the person is not detected. The angle information corresponding to the face information includes a head pitch angle, a head yaw angle, and a head roll angle of a face. The key point information includes a left shoulder point coordinate, a right shoulder point coordinate, and a center point coordinate. It is worth noting that, the angle information corresponding to the face information may include only required angles, such as a head yaw angle, and the key point information may include other key points recorded in FIG. 7 based on different applications.

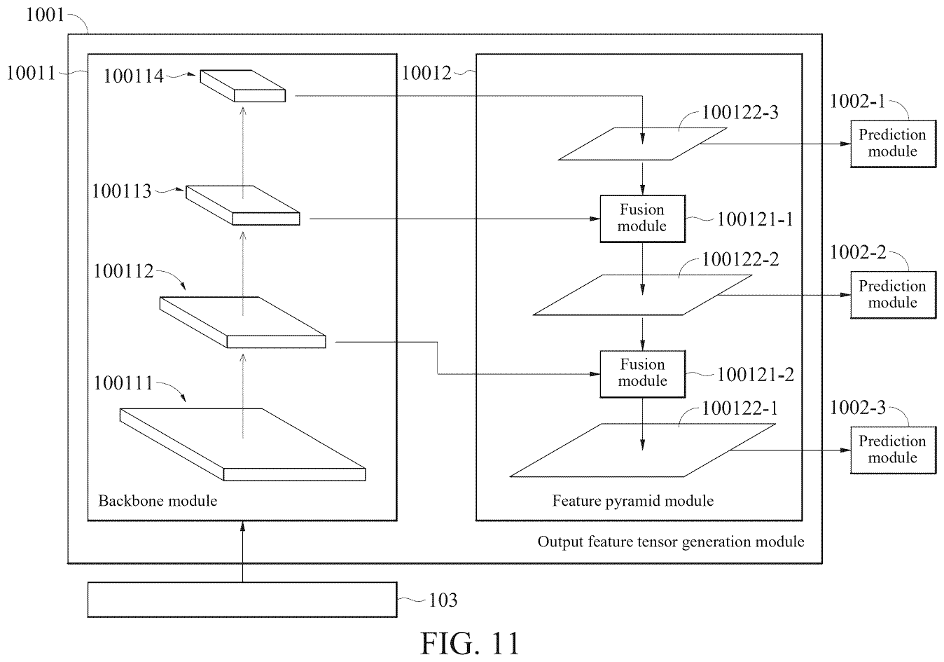

FIG. 11 is a block diagram of an output feature tensor generation module according to some embodiments of the present invention. A description is provided below by using an example of M=3 with reference to FIG. 10 to FIG. 11. The output feature tensor generation module 1001 includes a backbone module 10011 and a feature pyramid module 10012.

In some embodiments of the present invention, the backbone module 10011 includes backbone layers 100111-100114 of different sizes. The backbone module 10011 generates a plurality of feature tensors of different sizes in a first order through the backbone layers 100111-100114 based on the image 103. As shown in FIG. 11, the plurality of feature tensors are output tensors of the backbone layers 100112-100114. The first order is an order in which the feature tensors are arranged in descending order of sizes. The feature pyramid module 10012 performs feature fusion on the feature tensors to obtain a plurality of output feature tensors.

Referring to FIG. 11 and FIG. 22, in some embodiments of the present invention, step S2201 includes the following steps: generating, by the backbone module 10011, a plurality of feature tensors of different sizes in a first order through the backbone layers 100111 to 100114 based on the image 103, where the first order is an order in which the feature tensors are arranged in descending order of sizes; and performing, by the feature pyramid module 10012, feature fusion on the feature tensors of the different sizes in the first order generated by the backbone module 10011 through the backbone layers 100111-100114 based on image 103, to obtain output feature tensors.

Referring to FIG. 11, the feature pyramid module 10012 includes fusion modules 100121-1 to 100121-2. The feature pyramid module 10012 performs the following steps to perform the feature fusion on the feature tensors to obtain the plurality of output feature tensors.

First, the feature pyramid module 10012 sets a smallest feature tensor corresponding to a last position in the first order as one tensor in a temporary feature tensor set. For example, in the embodiment shown in FIG. 11, the smallest feature tensor is the output tensor of the backbone layer 100114. The smallest feature tensor is stored in a temporary feature tensor 100122-3 as one of the tensors in the temporary feature tensor set.

Next, the feature pyramid module 10012 performs an upsampling operation on the temporary feature tensor 100122-3 through the fusion module 100121-1, to obtain an upsampled temporary feature tensor 100122-3 of the same size as the output tensor of the backbone layer 100113. Then the feature pyramid module 10012 performs feature fusion on the upsampled temporary feature tensor 100122-3 and the output tensor of the backbone layer 100113 through the fusion module 100121-1, to obtain a temporary feature tensor 100122-2 of the same size as an output tensor of a convolution layer of the backbone layer 100113. Then the feature pyramid module 10012 performs feature fusion on the upsampled temporary feature tensor 100122-2 and the output tensor of the convolution layer of the backbone layer 100112 through the fusion module 100121-2, to obtain a temporary feature tensor 100122-1 of the same size as the output tensor of the convolution layer of the backbone layer 100112. The feature pyramid module 10012 outputs the temporary feature tensors 100122-3, 100122-2, and 100122-1 as the above plurality of output feature tensors of the feature pyramid module 10012.

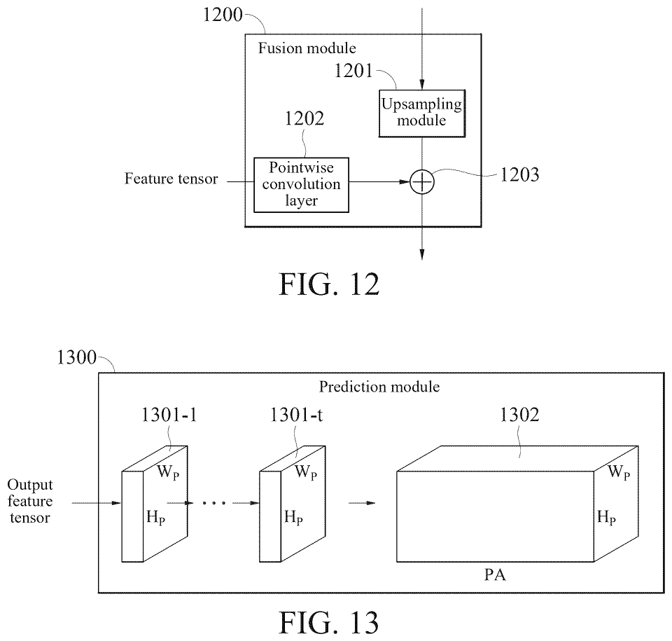

FIG. 12 is a block diagram of a fusion module according to some embodiments of the present invention. In FIG. 12, structures of the fusion modules 100121-1 to 100121-2 are shown as a fusion module 1200. The fusion module 1200 includes an upsampling module 1201, a pointwise convolution layer 1202, and a pointwise addition module 1203. The upsampling module 1201 is configured to perform an upsampling operation on an input of the upsampling module 1201. The upsampling operation is performed by repeating element twice of the input to the upsampling module 1201 in a height axis direction and a width axis direction thereof to double a size of the input to the upsampling module 1201. The pointwise convolution layer 1202 is configured to perform a pointwise convolution operation. The pointwise addition module 1203 is configured to perform a pointwise addition operation on two received input tensors to obtain an output tensor of the pointwise addition module 1203. It is worth noting that, the upsampling module 1201 may adopt other upsampling methods.

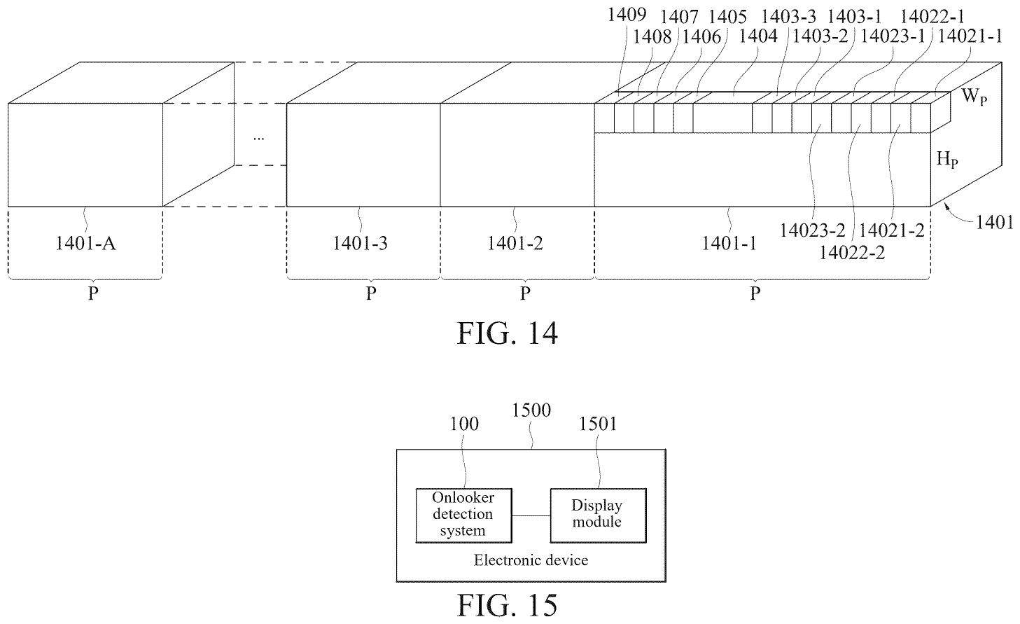

FIG. 13 is a schematic structural diagram of a prediction module according to some embodiments of the present invention. FIG. 14 is a schematic structural diagram of an information tensor according to some embodiments of the present invention. Referring to FIG. 13 to FIG. 14, structures of the prediction modules 1002-1 to 1002-3 are shown by a prediction module 1300. The prediction module 1300 includes t Wₚ×Hₚ×128 convolution layers, namely, convolution layers 1301-1 to 1301-t, and one Wₚ×Hₚ×PA convolution layer, namely, a convolution layer 1302. t is a positive integer. Wₚ and Hₚ are positive integers, which represent dimensions of width axes and height axes of the convolution layers 1301-1 to 1301-t. A is a positive integer, which represents a quantity of anchors. P is a positive integer. It is worth noting that, a convolution layer labeled as Wₚ×Hₚ×128 performs a convolution operation on an input tensor through 128 convolution kernels, and concatenates tensors obtained by the 128 convolution kernels by performing the convolution operation on the input tensor to obtain an output tensor with a width axis quantity of Wₚ, a height axis quantity of Hₚ, and a channel quantity of a channel axis of 128. The output tensor is a tensor with a dimension of Wₚ×Hₚ×128.

The neural network module 1000 sets A anchors of different sizes on the above plurality of output feature tensors. A value of P is 4+1+quantity of all categories+3+6. 4 represents a quantity of tensor elements required for describing a position coordinate of a vertex in an anchor, a detection width, and a detection height. 1 represents that a possibility that a detection target exists in the anchor and an accuracy of the anchor are described with 1 tensor element. 3 represents a quantity of tensor elements required for describing a head pitch angle, a head yaw angle, and a head roll angle of a face. 6 represents a quantity of tensor elements required for describing a left shoulder point coordinate, a right shoulder point coordinate, and a center point coordinate (each coordinate requires two tensors). Values of Wₚ, Hₚ, P, A, and t may be set by a user based on a demand. It is worth noting that, since the output feature tensors received by the prediction modules 1002-1 to 1002-M have different sizes, Wₚ and Hₚ of each of the prediction modules 1002-1 to 1002-M have different values.

The prediction module 1300 receives any of the above plurality of output feature tensors. After the output feature tensor passes through the convolution layers 1301-1 to 1301-t and the convolution layer 1302 of the prediction module 1300, an information tensor 1401 can be obtained. The information tensor 1401 includes sub-information tensors 1401-1 to 1401-A. Each of the sub-information tensors 1401-1 to 1401-A corresponds to one of the above A anchors. Each of the sub-information tensors 1401-1 to 1401-A includes Wₚ·Hₚ P-dimensional vectors. As shown in FIG. 14, each P-dimensional vector includes tensor elements 14021-1, 14021-2, 14022-1, 14022-2, 14023-1, 14023-2, 1403-1, 1403-2, 1403-3, and 1404 to 1409. The tensor elements 14021-1, 14021-2, 14022-1, 14022-2, 14023-1, 14023-2, 1403-1, 1403-2, and 1403-3 respectively indicate an abscissa of a left shoulder point (for example, the left shoulder point 6012), an ordinate of the left shoulder point, an abscissa of a right shoulder point, an ordinate of the right shoulder point, an abscissa of a center point, an ordinate of the center point, and a head pitch angle, a head yaw angle, and a head roll angle of a face.

The tensor element 1404 includes a plurality of sub-tensor elements. Each sub-tensor element of the tensor element 1404 indicates a probability that an object in an anchor box belongs to each category. The tensor element 1405 indicates a confidence score, which represents a possibility that a detection target exists in the anchor and an accuracy of the anchor. The tensor element 1406 indicates a height of the anchor. The tensor element 1407 indicates a width of the anchor. The tensor elements 1408 and 1409 indicate coordinates of the anchor. The face information includes the coordinates of the anchor, the height of the anchor, and the width of the anchor. The probability that the object in an anchor belongs to each category is the above category information. The confidence score is the above confidence score information. The angle information corresponding to the face information includes the head pitch angle, the head yaw angle, and the head roll angle of the face. The key point information includes the abscissa of the left shoulder point, the ordinate of the left shoulder point, the abscissa of the right shoulder point, the ordinate of the right shoulder point, the abscissa of the center point, and the ordinate of the center point. The person detection module 101 may integrate all information tensors generated by the prediction modules 1002-1 to 1002-M, to obtain the person information of each person.

It is worth noting that, the person detection module 101 may integrate all of the information tensors generated by the prediction modules 1002-1 to 1002-M, to obtain the width and the height of the face box. In some embodiments of the present invention, the onlooker detection system 100 captures the image 103 by using a lens arranged at a fixed position on the device. Therefore, the width and the height of the face box are inversely proportional to a distance of the face relative to the lens (also relative to the device). Therefore, the person detection module 101 may obtain the distance of the face relative to the lens based on the width or the height of the face box.

It is worth noting that, for training the neural network module 1000 in FIG. 10 to FIG. 15, data such as the head pitch angle, the head yaw angle, the head roll angle, the left shoulder point coordinate, the right shoulder point coordinate, and the center point coordinate of the face are added to a training set, and then training is performed by using an object detection model training method, to obtain a trained neural network module 1000.

In FIG. 10 to FIG. 15, the prediction modules 1002-1 to 1002-M are referred to as network heads in the art of the present invention. The prediction modules 1002-1 to 1002-M disclosed in the above embodiments can replace network headers of other one-stage object detection models, so that the one-stage object detection models can output person information. The present invention is not limited to the above backbone module 10011 and feature pyramid module 10012.

What is claimed is:

1. An onlooker detection system, comprising:
a person detection module, configured to receive an image, and obtain, in response to presence of at least one person in the image, person information of each of the at least one person, wherein the person information comprises distance information relative to a device; and
an onlooker determination module, configured to:
(a) determine whether the at least one person comprises at least one non-user present in a range based on the distance information of the person information of each of the at least one person; and
(b) determine, in response to presence of the at least one non-user in the range, a security classification to which each of the at least one non-user belongs based on the person information of each of the at least one non-user, wherein the security classification comprises an onlooker category.

2. The onlooker detection system according to claim 1, wherein the security classification comprises a non-onlooker category, and step (b) comprises:
(b1) determining, for a current object of the at least one non-user, whether the current object faces the device; determining that the current object belongs to the onlooker category in response to the current object facing the device; and determining that the current object belongs to the non-onlooker category in response to the current object not facing the device; and
(b2) selecting, in response to the at least one non-user comprising an unselected object, an unselected one of the at least one non-user as the current object, and returning to step (b1).

3. The onlooker detection system according to claim 1, wherein the security classification comprises a passerby category and a sharing user category, and step (b) comprises:
(b1) determining, for a current object of the at least one non-user, whether a distance between the current object and a user is less than a preset distance; determining, in response to the distance between the current object and the user being less than the preset distance, that the current object belongs to the sharing user category; determining, in response to the distance between the current object and the user being not less than the preset distance, whether the current object faces the device; determining that the current object belongs to the onlooker category in response to the current object facing the device, and determining that the current object belongs to the passerby category in response to the current object not facing the device; and
(b2) selecting, in response to the at least one non-user comprising an unselected object, an unselected one of the at least one non-user as the current object, and returning to step (b1).

4. The onlooker detection system according to claim 2, wherein the person information comprises face information, angle information corresponding to the face information, and key point information, and the step of determining whether the current object faces the device comprises: (b11) determining, based on face information of the current object, whether a face of the current object is detected; (b12) determining whether the current object faces the device based on angle information of the current object corresponding to the face information in response to the face of the current object being detected; and (b13) determining, in response to the face of the current object not being detected, whether the current object faces the device based on key point information of the current object.

5. The onlooker detection system according to claim 4, wherein the angle information of the current object corresponding to the face information comprises a head yaw angle, and step (b12) comprises: determining that the current object faces the device in response to the head yaw angle being in an angle threshold range; and determining that the current object does not face the device in response to the head yaw angle being not in the angle threshold range.

6. The onlooker detection system according to claim 4, wherein the angle information of the face information of the current object comprises a gaze point yaw angle, and step (b12) comprises: determining that the current object faces the device in response to the gaze point yaw angle being in an angle threshold range; and determining that the current object does not face the device in response to the gaze point yaw angle being not in the angle threshold range.

7. The onlooker detection system according to claim 4, wherein the key point information of the current object comprises a left shoulder point coordinate, a right shoulder point coordinate, and a center point coordinate, and step (b13) comprises:
(b131) calculating a first distance between the left shoulder point coordinate and the center point coordinate, and calculating a second distance between the right shoulder point coordinate and the center point coordinate; dividing the first distance by a distance of the current object relative to the device to obtain a first normalized distance, and dividing the second distance by the distance of the current object relative to the device to obtain a second normalized distance; and determining whether an absolute value of a difference between the first normalized distance and the second normalized distance is greater than a distance difference threshold; and
(b132) determining that the current object faces the device in response to the absolute value of the difference between the first normalized distance and the second normalized distance being not greater than the distance difference threshold; and determining that the current object does not face the device in response to the absolute value of the difference between the first normalized distance and the second normalized distance being greater than the distance difference threshold.

8. The onlooker detection system according to claim 1, wherein the onlooker determination module is configured to transmit, in response to determining that one of the at least one non-user belonging to the onlooker category, a signal to cause the device to start initiating an anti-peeping program.

9. The onlooker detection system according to claim 1, wherein the person detection module comprises a neural network module, the neural network module is configured to receive the image, and output a plurality of information tensors in response to the presence of the at least one person in the image, and the person detection module is configured to output the person information of each of the at least one person based on the information tensors in response to the presence of the at least one person in the image.

10. The onlooker detection system according to claim 9, wherein the neural network module comprises an output feature tensor generation module and a plurality of prediction modules, wherein the output feature tensor generation module is configured to generate a plurality of output feature tensors of different sizes based on the image, each of the prediction modules is configured to receive a corresponding one of the output feature tensors, to generate the information tensors, and each of the information tensors is configured to indicate face information, confidence score information, category information, angle information corresponding to the face information, and key point information.

11. An onlooker detection method, comprising:
receiving an image and obtaining, in response to presence of at least one person in the image, person information of each of the at least one person, by a person detection module, wherein the person information comprises distance information relative to a device; and
performing the following steps, by an onlooker determination module:
(a) determining whether the at least one person comprises at least one non-user present in a range based on the distance information of the person information of each of the at least one person; and
(b) determining, in response to presence of the at least one non-user in the range, a security classification to which each of the at least one non-user belongs based on the person information of each of the at least one non-user, wherein the security classification comprises an onlooker category.

12. The onlooker detection method according to claim 11, wherein the security classification comprises a non-onlooker category, and step (b) comprises:
(b1) determining, for a current object of the at least one non-user, whether the current object faces the device; determining that the current object belongs to the onlooker category in response to the current object facing the device; and determining that the current object belongs to the non-onlooker category in response to the current object not facing the device; and
(b2) selecting, in response to the at least one non-user comprising an unselected object, an unselected one of the at least one non-user as the current object, and returning to step (b1).

13. The onlooker detection method according to claim 11, wherein the security classification comprises a passerby category and a sharing user category, and step (b) comprises:
(b1) determining, for a current object of the at least one non-user, whether a distance between the current object and a user is less than a preset distance; determining, in response to the distance between the current object and the user being less than the preset distance, that the current object belongs to the sharing user category; determining, in response to the distance between the current object and the user being not less than the preset distance, whether the current object faces the device; determining that the current object belongs to the onlooker category in response to the current object facing the device, and determining that the current object belongs to the passerby category in response to the current object not facing the device; and
(b2) selecting, in response to the at least one non-user comprising an unselected object, an unselected one of the at least one non-user as the current object, and returning to step (b1).

14. The onlooker detection method according to claim 12, wherein the person information comprises face information, angle information corresponding to the face information, and key point information, and the step of determining whether the current object faces the device comprises: (b11) determining, based on face information of the current object, whether a face of the current object is detected; (b12) determining whether the current object faces the device based on angle information of the current object corresponding to the face information in response to the face of the current object being detected; and (b13) determining, in response to the face of the current object not being detected, whether the current object faces the device based on key point information of the current object.

15. The onlooker detection method according to claim 14, wherein the angle information of the current object corresponding to the face information comprises a head yaw angle, and step (b12) comprises: determining that the current object faces the device in response to the head yaw angle being in an angle threshold range; and determining that the current object does not face the device in response to the head yaw angle being not in the angle threshold range.

16. The onlooker detection method according to claim 14, wherein the angle information of the face information of the current object comprises a gaze point yaw angle, and step (b12) comprises: determining that the current object faces the device in response to the gaze point yaw angle being in an angle threshold range; and determining that the current object does not face the device in response to the gaze point yaw angle being not in the angle threshold range.

17. The onlooker detection method according to claim 14, wherein the key point information of the current object comprises a left shoulder point coordinate, a right shoulder point coordinate, and a center point coordinate, and step (b13) comprises:
(b131) calculating a first distance between the left shoulder point coordinate and the center point coordinate, and calculating a second distance between the right shoulder point coordinate and the center point coordinate; dividing the first distance by a distance of the current object relative to the device to obtain a first normalized distance, and dividing the second distance by the distance of the current object relative to the device to obtain a second normalized distance; and determining whether an absolute value of a difference between the first normalized distance and the second normalized distance is greater than a distance difference threshold; and
(b132) determining that the current object faces the device in response to the absolute value of the difference between the first normalized distance and the second normalized distance being not greater than the distance difference threshold; and determining that the current object does not face the device in response to the absolute value of the difference between the first normalized distance and the second normalized distance being greater than the distance difference threshold.

18. The onlooker detection method according to claim 11, further comprising: transmitting, in response to determining that one of the at least one non-user belonging to the onlooker category, a signal to cause the device to start executing an anti-peeping program.

19. The onlooker detection method according to claim 11, wherein the person detection module comprises a neural network module, and step (a) comprises:
(a1) receiving the image, and outputting a plurality of information tensors, by the neural network module, in response to the presence of the at least one person in the image; and
(a2) outputting, by the person detection module, the person information of each of the at least one person based on the information tensors in response to the presence of the at least one person in the image.

20. The onlooker detection method according to claim 19, wherein the neural network module comprises an output feature tensor generation module and a plurality of prediction modules, and step (a1) comprises:
(a11) generating, by the output feature tensor generation module, a plurality of output feature tensors of different sizes based on the image; and
(a12) receiving, by each of the prediction modules, a corresponding one of the output feature tensors, to generate the information tensors, wherein each of the information tensors is configured to indicate face information, confidence score information, category information, angle information corresponding to the face information, and key point information.
